(19) United States
(12) Patent Application Publication
(10) Pub. No.: US 2025/0202001 A1
(43) Pub. Date: Jun. 19, 2025

(54) SEALING TAPE FOR ALL-SOLID-STATE RECHARGEABLE BATTERY AND ALL-SOLID-STATE RECHARGEABLE BATTERY INCLUDING THE SAME

(71) Applicant: SAMSUNG SDI CO., LTD., Yongin-si (KR)

(72) Inventors: Ik Hwan CHO, Yongin-si (KR); Jiwan YOU, Yongin-si (KR); Changhee WOO, Yongin-si (KR); Young Gyoon RYU, Yongin-si (KR)

(21) Appl. No.: 18/941,040

(22) Filed: Nov. 8, 2024

(30) Foreign Application Priority Data
Dec. 18, 2023 (KR) 10-2023-0185038

(51) Int. Cl. H01M 50/231; H01M 50/227; H01M 50/233

(52) U.S. Cl. CPC H01M 50/231; H01M 50/227; H01M 50/233

(57) ABSTRACT

A sealing tape for an all-solid-state rechargeable battery including a substrate and an adhesive layer on a surface of the substrate, wherein the sealing tape has a creep value of greater than or equal to about 500 μm at 45° C. and a shear strength of greater than or equal to about 0.98 kgf/cm2 at 45° C.

### CROSS-REFERENCE TO RELATED APPLICATION

This application claims priority to and the benefit of Korean Patent Application No. 10-2023-0185038 filed in the Korean Intellectual Property Office on Dec. 18, 2023, the entire contents of which are incorporated herein by reference.

### BACKGROUND

### 1. Field

Embodiments relate to sealing tape for all-solid-state rechargeable battery and all-solid-state rechargeable battery including the same.

### 2. Description of the Related Art

A portable information device, e.g., a cell phone, a laptop, smart phone, or the like or an electric vehicle may use a rechargeable lithium battery having high energy density and easy portability as a driving power source. Recently, research has been actively conducted into using rechargeable lithium batteries with high energy density as a driving power source or power storage power source for hybrid or electric vehicles.

### SUMMARY

Embodiments are directed to a sealing tape for an all-solid-state rechargeable battery including a substrate and an adhesive layer on a surface of the substrate, wherein the sealing tape has a creep value of greater than or equal to about 500 μm at 45° C. and a shear strength of greater than or equal to about 0.98 kgf/cm² at 45° C.

A ratio of the creep value to a thickness of the adhesive layer may be greater than or equal to about 50 at 45° C.

The sealing tape may have a creep value of less than or equal to about 100 μm and a shear strength of greater than or equal to about 2.0 kgf/cm² at 25° C.

A ratio of the creep value to a thickness of adhesive layer may be less than or equal to about 15 at 25° C.

The sealing tape may have an adhesive force of greater than or equal to about 300 gf/mm at 25° C.

The sealing tape may have a thickness of about 10 μm to about 100 μm.

The substrate may have a thickness of about 5 μm to about 50 μm.

The adhesive layer may have a thickness of about 5 μm to about 50 μm.

The substrate may include polyethylene terephthalate, polyethylene, polypropylene, polyamide, polyimide, polyethylene naphthalate, polyacrylonitrile, poly(meth)acrylate, polymethyl(meth)acrylate, polyvinylidene fluoride, polytetrafluoroethylene, polyvinyl chloride, polyurethane, an epoxy resin, nylon resin, acryl resin, polystyrene, polyethylene oxide, polyvinyl alcohol, a silicone resin, a styrene-butadiene-rubber, an acrylonitrile-butadiene-rubber, hydrogenated nitrile-butadiene-rubber, or a copolymer thereof.

The adhesive layer may include an adhesive polymer and a molecular weight of the adhesive polymer may be about 800,000 g/mol to about 3,500,000 g/mol.

A glass transition temperature of the adhesive polymer may be about −50° C. to about −5° C.

The adhesive polymer may be derived from alkyl acrylate, hydroxyalkyl acrylate, cycloalkyl acrylate, or a combination thereof.

Embodiments are directed to an all-solid-state rechargeable battery, including a battery assembly including a positive electrode; a solid electrolyte layer; a negative electrode; and the sealing tape according to some embodiments attached to at least a portion of the exterior of the battery assembly.

The sealing tape may be attached to four or more regions of the battery assembly.

The sealing tape may be attached to about 5 area % to about 40 area %, based on a total external area of the battery assembly.

### BRIEF DESCRIPTION OF THE DRAWINGS

Features will become apparent to those of skill in the art by describing in detail exemplary embodiments with reference to the attached drawings in which:

FIG. 1 is a schematic view showing a sealing tape attached to an all-solid-state rechargeable battery according to some embodiments.

FIG. 2 is a top view of an all-solid-state rechargeable battery to which a sealing tape is attached according to some embodiments.

FIGS. 3 and 4 are cross-sectional views schematically showing an all-solid-state rechargeable battery according to some embodiments.

FIG. 5 is a view for explaining the shear strength evaluation method.

FIG. 6 is a view for explaining the creep evaluation method.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In addition, “layer” herein includes not only a shape formed on the whole surface when viewed from a plan view, but also a shape formed on a partial surface.

Herein, “or” is not to be construed as an exclusive meaning, for example, “A or B” is construed to include A, B, A+B, and the like.

In general, an all-solid-state rechargeable battery may not be manufactured or used while exposed to an atmosphere due to characteristics of a solid electrolyte. Therefore, an all-solid-state rechargeable battery may need to be separated from the atmosphere. For this purpose, the all-solid-state rechargeable battery may be pressured to form a laminate of the all-solid-state rechargeable battery to insert into an exterior body or compressed into a laminate film, wherein, cracks and short circuits may occur due to a stress transmitted to the solid electrolyte. In addition, the stress transmitted to the solid electrolyte through a pressurization or compression process may destroy the solid electrolyte.

Accordingly, the all-solid-state rechargeable battery may require a sealing tape with high shear strength to wrap the laminate so that a cell structure of the battery may not come apart when the laminate is inserted into an exterior body or a pouch. At the same time, the sealing tape may be required to have excellent creep strain characteristics during charge and discharge of the battery to disperse the stress applied to the solid electrolyte and apply a uniform surface pressure.

On the other hand, the all-solid-state rechargeable battery may have low coulombic efficiency due to changes in thickness of a negative electrode active material layer during charge and discharge. If a thickness of the negative electrode active material layer increases during charge, because the stress may be further applied to the solid electrolyte layer and a negative electrode current collector, an electrode reaction may occur in that state. If such stress is applied, the solid electrolyte layer and the negative electrode current collector, that is, the solids of the all-solid-state rechargeable battery, may not have good contact with each other but may still easily secure an ion conduction path and an electron conduction path. On the contrary, if the thickness of the negative electrode active material layer decreases during discharge, because stress may be relieved, the contact state of the solids may be worsened. As a result, because the ion conduction path and the electron conduction path may be easily interrupted, the all-solid-state rechargeable battery may have low coulombic efficiency.

Accordingly, a sealing tape according to some embodiments may help suppress the deterioration of the contact state between the solids by improving tracking properties of the negative electrode current collector, even if the thickness of the negative electrode active material layer is changed during charge and discharge.

Some embodiments relate to a method of suppressing the deterioration of the contact state between the solids, even if the thickness of the negative electrode active material layer changes due to charge and discharge, by improving the tracking properties of the negative electrode current collector to the change in thickness.

### Sealing Tape

In some embodiments, a sealing tape for an all-solid-state rechargeable battery may include a substrate and an adhesive layer on one surface of the substrate, wherein the sealing tape may have a creep value of greater than or equal to about 500 μm at 45° C. and a shear strength of greater than or equal to about 0.98 kgf/cm² at 45° C.

In an implementation, the sealing tape for an all-solid-state rechargeable battery according to some embodiments may have relatively excellent shear strength under charge and discharge conditions and excellent creep strain characteristics and an all-solid-state rechargeable battery including the same may effectively disperse stress applied to its cell structure, even if a thickness of a negative electrode active material layer may change during charge and discharge, and maintain a uniform pressure.

Accordingly, excellent contact between solids inside the battery may help ensure excellent ion and electron conduction, which may increase coulombic efficiency. In addition, because the stress applied to the cell structure may be dispersed, the solid electrolyte in the all-solid-state battery may be prevented from damage, improving a cycle-life of the all-solid-state battery.

The sealing tape for an all-solid-state rechargeable battery according to some embodiments may have a creep value of greater than or equal to about 500 μm at about 45° C., e.g., greater than or equal to about 450 μm, greater than or equal to about 400 μm, or greater than or equal to about 350 μm, e.g., about 500 μm to about 1000 μm, or about 500 μm to about 800 μm. A creep value may be a distance that an about 1 cm-wide tape attached to a glass moves when pulled with a force of about 1,000 gf at about 10 μm/s for about 5 minutes and may be measured using the same method as used in Evaluation 2. The creep value may be measured using a tape that has a total thickness of about 10 μm to about 100 μm, e.g., about 30 μm or about 35 μm, and an adhesive layer thickness of about 5 μm to about 50 μm, e.g., about 5 μm or about 10 μm. The higher the creep value, the higher the strain rate, flexibility, or elasticity of the tape may be. The sealing tape according to some embodiments may exhibit a creep value of greater than or equal to about 500 μm at about 45° C. which may be close to the driving condition, e.g., the driving temperature, of the all-solid-state rechargeable battery and thus the sealing tape according to some embodiments may flexibly expand and contract in accordance with thickness changes of the battery according during charge and discharge, thereby effectively relieving the stress applied to the battery.

In an implementation, the sealing tape may have a shear strength of greater than or equal to about 0.98 kgf/cm² at about 45° C., e.g., greater than or equal to about 0.95 kgf/cm², greater than or equal to about 0.93 kgf/cm², greater than or equal to about 0.90 kgf/cm², or greater than or equal to about 0.85 kgf/cm², e.g., about 0.98 kgf/cm² to about 2 kgf/cm² or about 0.98 kgf/cm² to about 1.5 kgf/cm². The shear strength may be the force required to pull a tape with a size of (1 in)×(1 in) at greater than or equal to about 12.5 mm/min and may be measured using the same method as in Evaluation 1. The shear strength may be measured using a tape having a total thickness of about 10 μm to about 100 μm, e.g., about 30 μm or about 35 μm, and an adhesive layer having a thickness of about 5 μm to about 50 μm, e.g., about 5 μm or about 10 μm. The higher the shear strength, the better the tape may maintain a shape or an adhesive force without being broken, at a high shear force. The sealing tape according to some embodiments may realize a shear strength of greater than or equal to about 0.98 kgf/cm² at about 45° C. and even if the all-solid-state rechargeable battery expands during charge and discharge, and a shear force may therefore be applied to the tape, the tape may be neither torn off nor broken but may maintain an excellent adhesive force.

The sealing tape according to some embodiments, which may simultaneously satisfy a creep value and a shear strength within each of the above ranges at about 45° C., may be flexibly transformed, e.g., may be stretched, according to thickness changes of the all-solid-state rechargeable battery during charge and discharge and may relieve stress applied to the solid-state rechargeable battery and simultaneously, firmly maintain its shape without being broken by the resulting shear force.

In an implementation, the all-solid-state rechargeable battery finished with the sealing tape may be pressured evenly on all sides in a laminating direction, even if repeatedly charged and discharged, thereby helping resolve problems resulting from stress that may be locally concentrated and ultimately improving overall performance, e.g., coulombic efficiency, cycle-life characteristics, or the like.

In an implementation, the sealing tape may have a creep value (μm) to a thickness of the adhesive layer (μm) ratio of greater than or equal to about 50 at 45° C., e.g., greater than or equal to about 60, greater than or equal to about 70, greater than or equal to about 80, or greater than or equal to about 85, e.g., about 50 to about 200, or about 50 to about 100. If the sealing tape has a creep value to thickness of the adhesive layer ratio within the above ranges at about 45° C., even if a volume of the all-solid-state rechargeable battery expands during the charge and discharge, the sealing tape may flexibly withstand the volume expansion of the all-solid-state rechargeable battery and enable the cell structure inside the battery to be integrally formed.

The sealing tape may have a creep value of less than or equal to about 100 μm at room temperature (e.g., about 25° C.), e.g., less than or equal to about 90 μm, less than or equal to about 85 μm, or less than or equal to about 80 μm, about 30 μm to about 100 μm, or about 50 μm to about 80 μm. If the sealing tape satisfies a creep value at room temperature within these ranges, the sealing tape may not be easily transformed at room temperature and may maintain a firm adhesive force and the all-solid-state rechargeable battery may well maintain a pressurized battery shape, even if stored or moved at room temperature.

In an implementation, the sealing tape may have shear strength of greater than or equal to about 2.0 kgf/cm² at about 25° C., e.g., greater than or equal to about 2.5 kgf/cm², greater than or equal to about 3.0 kgf/cm², or greater than or equal to about 3.5 kgf/cm², e.g., about 2.5 kgf/cm² to about 8 kgf/cm² or about 2.5 kgf/cm² to about 5 kgf/cm². If the sealing tape has shear strength within these ranges at room temperature, the sealing tape may maintain a solid shape, so that the all-solid-state rechargeable battery may be well maintained in a pressurized state.

In an implementation, the sealing tape may have a creep to a thickness of the adhesive layer ratio at about 25° C. of less than or equal to about 15, e.g., less than or equal to about 15, less than or equal to about 13, or less than or equal to about 11, e.g., about 3 to about 10 or about 5 to about 10. If the sealing tape satisfies a creep to a thickness of the adhesive layer ratio within these ranges at room temperature, appropriate shear strains may be realized, firmly maintaining the all-solid-state rechargeable battery in the pressurized state.

The sealing tape may have an adhesive force of greater than or equal to about 300 gf/mm at about 25° C., e.g., about 300 gf/mm to about 800 gf/mm, about 300 gf/mm to about 500 gf/mm, or about 350 gf/mm to about 450 gf/mm. The adhesive force may be a force required to peel off the tape in a 180° direction, e.g., at a 180° angle, and specifically may be measured using the same method as in Evaluation 3. If the sealing tape realizes an adhesive force within these ranges at room temperature, the sealing tape may significantly firmly hold the pressurized all-solid-state rechargeable battery, which may not come apart.

If the sealing tape according to some embodiments satisfies the above ranges of a creep value, shear strength, and a creep to a thickness of the adhesive layer ratio at 25° C., the cell structure inside the battery may not come apart but be integrated, if the battery is manufactured, stored, and moved, and deformation of the battery may be prevented, improving reliability of the battery.

The sealing tape according to some embodiments may have a thickness of about 10 μm to about 100 μm, e.g., about 15 μm to about 100 μm, about 20 μm to about 100 μm, about 25 μm to about 100 μm, about 30 μm to about 100 μm, about 10 μm to about 95 μm, about 10 μm to about 90 μm, about 10 μm to about 85 μm, or about 10 μm to about 80 μm. If the sealing tape has a thickness in the above ranges, it may realize physical properties, e.g., appropriate shear strength, making it suitable for application as a finishing tape for an all-solid-state battery.

### (Substrate)

The substrate of the sealing tape may have a thickness of about 5 μm to about 50 μm, e.g., about 10 μm to about 50 μm, about 15 μm to about 50 μm, about 20 μm to about 50 μm, about 5 μm to about 40 μm, or about 5 μm to about 30 μm. Maintaining the thickness of the substrate within the above ranges may help ensure that physical properties, e.g., appropriate shear strength may be achieved.

The substrate may include, e.g., polyethylene terephthalate, polyethylene, polypropylene, polyamide, polyimide, polyethylene naphthalate, polyacrylonitrile, poly(meth)acrylate, polymethyl(meth)acrylate, polyvinylidene fluoride, polytetrafluoroethylene, polyvinyl chloride, polyurethane, an epoxy resin, nylon resin, acryl resin, polystyrene, polyethylene oxide, polyvinyl alcohol, a silicone resin, a styrene-butadiene-rubber, an acrylonitrile-butadiene-rubber, hydrogenated nitrile-butadiene-rubber, a copolymer thereof, or a mixture thereof. In an implementation, the substrate may be a polyethylene terephthalate (PET) film, urethane film, acrylic film, epoxy film, or EVA film. In an implementation, it may be a polyethylene terephthalate film.

### (Adhesive Layer)

The adhesive layer of the sealing tape may have a thickness of about 5 μm to about 50 μm, e.g., about 10 μm to about 50 μm, about 15 μm to about 50 μm, about 20 μm to about 50 μm, about 5 μm to about 40 μm, or about 5 μm to about 30 μm. Maintaining the thickness of the adhesive layer within the above ranges may help ensure that excellent adhesive force may be achieved while exhibiting physical properties, e.g., shear strength and creep value.

The adhesive layer may include an adhesive polymer, and a molecular weight of the adhesive polymer may be about 800,000 g/mol to about 5,000,000 g/mol, e.g., about 800,000 g/mol to about 4,000,000 g/mol, about 800,000 g/mol to about 3,500,000 g/mol, e.g., about 1,000,000 g/mol to about 5,000,000 g/mol, about 1,000,000 g/mol to about 4,500,000 g/mol, about 1,500,000 g/mol to about 4,500,000 g/mol, about 1,700,000 g/mol to about 5,000,000 g/mol, about 2,000,000 g/mol to about 5,000,000 g/mol, about 1,500,000 g/mol to about 4,500,000 g/mol, or about 1,500,000 g/mol to about 4,000,000 g/mol. Herein, the molecular weight may be a value measured using gel permeation chromatography (GPC). Maintaining the molecular weight of the adhesive polymer within the above ranges may help ensure that a sealing tape including it may exhibit high adhesion and shear strength at room temperature while achieving excellent strain rate, e.g., strain characteristics, at a high temperature of, e.g., 45° C.

The glass transition temperature (T_{g}) of the adhesive polymer may be about −50° C. to about −5° C., e.g., about −45° C. to about −5° C., about −40° C. to about −5° C., about 35° C. to about −5° C., about 30° C. to about −5° C., about −40° C. to about −10° C., or about −40° C. to about −15° C. Herein, the glass transition temperature may be measured using DSC (TA Instrument) equipment. Maintaining the glass transition temperature of the adhesive polymer within the above ranges may help ensure that a sealing tape including it may exhibit high adhesion and shear strength at room temperature and excellent strain rate at a high temperature of, e.g., 45° C.

The adhesive polymer of the adhesive layer included in the sealing tape according to some embodiments may have a molecular weight and glass transition temperature in the above ranges and the sealing tape may have excellent shear strength at room temperature and at the same time have high strain characteristics under battery charging and discharging conditions. In an implementation, the coulombic efficiency of an all-solid-state rechargeable battery including the sealing tape may be increased.

A suitable adhesive polymer that satisfies the ranges of molecular weight and glass transition temperature may be used. In an implementation, the adhesive polymer may be derived from a compound including alkyl acrylate, hydroxyalkyl acrylate, cycloalkyl acrylate, or a combination thereof.

The alkyl acrylate may be, e.g., a substituted or unsubstituted C1 to C20 alkyl (meth)acrylate compound, e.g., ethyl hexyl(meth)acrylate, methyl(meth)acrylate, ethyl(meth)acrylate, propyl(meth)acrylate, butyl(meth)acrylate, pentyl(meth)acrylate, hexyl(meth)acrylate, heptyl(meth)acrylate, octyl(meth)acrylate, nonyl(meth)acrylate, decyl(meth)acrylate, dodecyl(meth)acrylate, lauryl(meth)acrylate, or a combination thereof.

The hydroxyalkyl acrylate may be, e.g., a C1 to C20 alkyl (meth)acrylate compound substituted with a hydroxy group, e.g., 2-hydroxyethyl(meth)acrylate, 4-hydroxybutyl(meth)acrylate, 2-hydroxypropyl(meth)acrylate, 2-hydroxybutyl(meth)acrylate, 6-hydroxyhexyl(meth)acrylate, 1,4-cyclohexanedimethanolmono (meth)acrylate, chloro-2-hydroxypropylacrylate, diethylene glycolmono (meth)acrylate, allyl alcohol, or a combination thereof.

The cycloalkyl acrylate may be, e.g., a substituted or unsubstituted C3 to C20 cycloalkyl (meth)acrylate compound, e.g., cyclohexyl(meth)acrylate, isobornyl (meth)acrylate, or a combination thereof. In the above, (meth)acrylate may refer to both acrylate and methacrylate.

In an implementation, the adhesive polymer may be formed by crosslinking the aforementioned acrylate compound with a crosslinking agent. The crosslinking agent may be a multifunctional (meth)acrylate that can be cured with active energy rays.

The multifunctional (meth)acrylates may include, e.g., difunctional acrylate, e.g., 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, dicyclopentanyl di(meth)acrylate, caprolactone modified dicyclopentenyl di(meth)acrylate, ethylene oxide modified di(meth)acrylate, di(meth)acryloxy ethyl isocyanurate, allyl cyclohexyl di(meth)acrylate, tricyclodecanedimethanol (meth)acrylate, dimethylol dicyclopentanedi(meth)acrylate, ethylene oxide modified hexahydrophthalic acid di(meth)acrylate, tricyclodecane dimethanol (meth)acrylate, neopentyl glycol modified trimethylpropane di(meth)acrylate, adamantane di(meth)acrylate, or 9,9-bis [4-(2-acryloyloxyethoxy)phenyl]fluorene; trifunctional acrylate, e.g., trimethylolpropane tri (meth)acrylate, dipentaerythritol tri (meth)acrylate, propionic acid modified dipentaerythritol tri (meth)acrylate, pentaerythritol tri (meth)acrylate, propylene oxide modified trimethylolpropane tri (meth)acrylate, trifunctional urethane (meth)acrylate, or tris (meth)acryloxyethylisocyanurate; tetrafunctional acrylate, e.g., diglycerine tetra (meth)acrylate or pentaerythritol tetra(meth)acrylate; pentafunctional acrylate, e.g., dipentaerythritol penta (meth)acrylate; and hexafunctional acrylate, e.g., dipentaerythritol hexa (meth)acrylate, caprolactone modified dipentaerythritol hexa (meth)acrylate or urethane (meth)acrylate, e.g., a reaction product of isocyanate monomer and trimethylolpropane tri (meth)acrylate, or the like. These can be used alone or in combination of two or more types.

In an implementation, suitable isocyanate, epoxy, aziridine, melamine, amine, imide, carbodiimide, amide crosslinking agents, or a combination thereof may be used.

In the adhesive layer, a content of the crosslinking agent may be, e.g., about 0.01 to about 5 parts by weight, e.g., about 0.03 to about 3 parts by weight, e.g., about 0.05 to about 2 parts by weight, based on 100 parts by weight of the (meth)acrylic copolymer.

The adhesive layer including the adhesive polymer may have a crosslinking degree of about 85% to about 98%. Here, a degree of crosslinking may be confirmed by a gel fraction (gel content). If the degree of crosslinking of the adhesive layer is less than about 85%, the adhesive layer may swell and disperse. On the other hand, if the degree of crosslinking of the adhesive layer is greater than about 98%, rigidity of the adhesive layer may be excessively high.

The adhesive layer may be manufactured by curing an adhesive layer composition including the acrylic compound and the crosslinking agent. In an implementation, the adhesive layer composition may be coated on a release film and then UV cured. In an implementation, the UV curing can be performed under conditions of less than or equal to about 50 mW.

The adhesive layer composition may optionally further include suitable additives, e.g., a silane coupling agent, a curing accelerator, ionic liquid, a lithium salt, an inorganic filler, a softener, an antioxidant, an anti-aging agent, a stabilizer, a tackifying resin, a modifying resin, a leveling agent, an anti-foaming agent, a plasticizer, a dye, pigment, e.g., a coloring pigment, or an extender pigment, a processing agent, an ultraviolet blocking agent, an optical whitening agent, a dispersant, a heat stabilizer, a light stabilizer, an ultraviolet absorber, an antistatic agent, a lubricant, and a solvent. The modified resin may further include, e.g., polyol resin, phenol resin, acrylic resin, polyester resin, polyolefin resin, epoxy resin, epoxidized polybutadiene resin, etc., and may remain in the final adhesive layer.

By appropriately adjusting the type or content of acrylic compounds, crosslinking agents, and additives in the adhesive layer composition used to form the adhesive layer described above, the molecular weight and T_{g} of the adhesive polymer, and the physical properties of the adhesive layer formed from the adhesive layer composition, or the like, it may be possible to provide a sealing tape according to some embodiments having creep values and shear strengths in specific ranges at 45° C. and 25° C., respectively.

All-solid-state Rechargeable Battery

In some embodiments, an all-solid-state rechargeable battery may include a battery assembly including a positive electrode, a solid electrolyte layer, and a negative electrode, and the aforementioned sealing tape for an all-solid-state rechargeable battery attached to at least a portion of the exterior of the battery assembly.

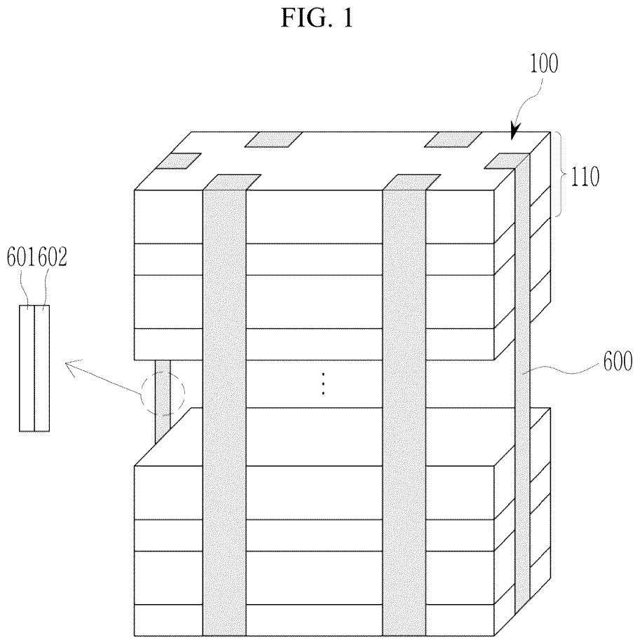

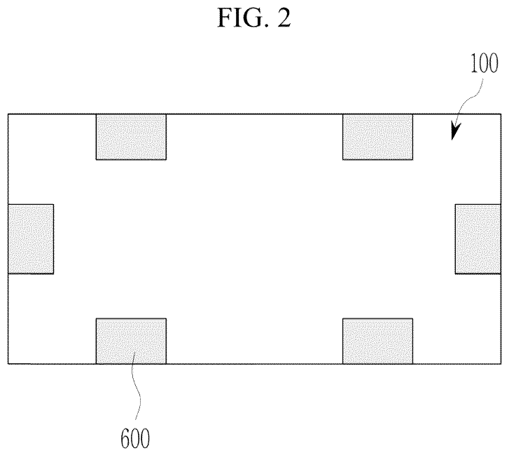

FIG. 1 is a schematic view schematically showing an example in which a sealing tape according to some embodiments is attached to an all-solid-state rechargeable battery 100. FIG. 2 is a top view of the all-solid-state rechargeable battery 100 of FIG. 1 as seen from above. As shown in FIG. 1, the sealing tape 600 for an all-solid-state rechargeable battery according to some embodiments may help the cell structures 110 of the battery form an integrally laminated structure without being separated. Additionally, as shown in FIG. 1, the sealing tape 600 may include a substrate 601 and an adhesive layer 602.

The sealing tape 600 may be attached to four or more regions, five or more regions, six or more regions of the battery assembly. FIG. 1 shows a sealing tape 600 attached to six regions on a battery assembly. In the above, “region” may refer to the number of sealing tapes attached over three or more sides of the battery assembly. The sealing tape may be attached in any suitable shape, as long as the cell structures forming the battery assembly may be integrated.

The sealing tape 600 may be attached to, e.g., cover, about 5 area % to about 40 area %, e.g., about 10 area % to about 40 area %, about 15 area % to about 40 area %, about 5 area % to about 35 area %, or about 5 area % to about 30 area %, based on a total external area of the battery assembly. Attaching the sealing tape to the battery assembly in the above ranges may help ensure that the sealing tape may integrate the cell structure at room temperature, and at the same time, even if the volume of the all-solid-state rechargeable battery expands under battery charging and discharging conditions, the sealing tape can flexibly withstand the expansion, and the coulombic efficiency of the all-solid-state rechargeable battery including the sealing tape may be increased.

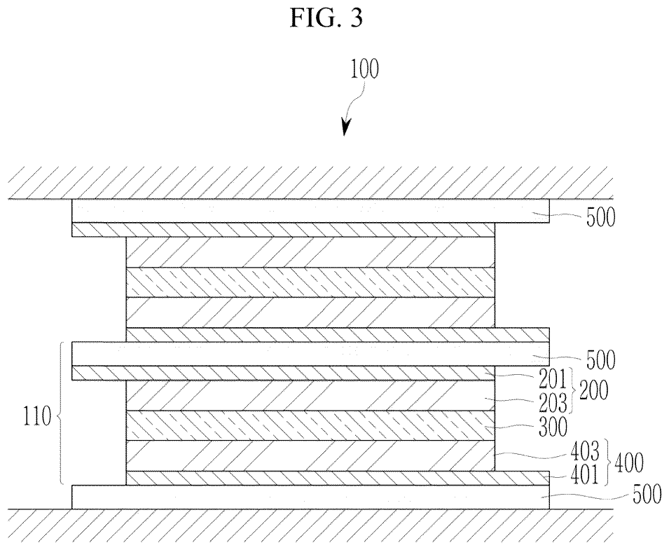

In an implementation, an all-solid-state rechargeable battery may include two or more cell structures 110 including a positive electrode, a negative electrode, and a solid electrolyte layer located between the positive electrode and the negative electrode. FIG. 3 is a cross-sectional view of an all-solid-state rechargeable battery according to some embodiments. Referring to FIG. 3, the all-solid-state rechargeable battery 100 may include a cell structure 110 in which a negative electrode 400 including a negative electrode current collector 401 and a negative electrode active material layer 403, a solid electrolyte layer 300, and a positive electrode 200 including a positive electrode current collector 201 and a positive electrode active material layer 203 are laminated and housed in a battery case.

One cell structure 110 may include one or more negative electrodes, and may likewise include one or more solid electrolyte layers and one or more positive electrodes. In an implementation, the cell structure 110 may be in the form of a monocell with a negative electrode/solid electrolyte layer/positive electrode structure or a bicell form with a negative electrode/solid electrolyte layer/positive electrode/solid electrolyte layer/negative electrode structure. FIG. 3 shows an assembly in which two cell structures 110 including the negative electrode 400, the solid electrolyte layer 300, and the positive electrode 200 are laminated, but three or more, e.g., 2 to 200, 3 to 100, or 4 to 50, may be laminated.

In an implementation, the all-solid-state rechargeable battery 100 may further include an elastic layer 500 outside at least one of the positive electrode 200 and the negative electrode 400. The elastic layer 500 may help ensure good contact between solid components by uniformly transmitting pressure to the electrode laminate, and may play a role in relieving stress transmitted to the solid electrolyte, and in suppressing the occurrence of cracks in the solid electrolyte due to stress accumulation depending on changes in the thickness of the electrode during charging and discharging.

### Positive Electrode

In some embodiments, the positive electrode may include a current collector and a positive electrode active material layer on the current collector, and the positive electrode active material layer may include a positive electrode active material and may optionally include a solid electrolyte, a binder, or a conductive material.

### Positive Electrode Active Material

The positive electrode active material may include a compound, e.g., a lithiated intercalation compound, being capable of intercalating and deintercalating lithium. In an implementation, at least one of a composite oxide of lithium and a metal, e.g., cobalt, manganese, nickel, and combinations thereof may be used.

The composite oxide may be a lithium transition metal composite oxide, e.g., lithium nickel oxide, lithium cobalt oxide, lithium manganese oxide, lithium iron phosphate compound, cobalt-free lithium nickel-manganese oxide, overlithiated layered oxide, or a combination thereof.

In an implementation, the positive electrode active material may be a high nickel positive electrode active material having a nickel content of greater than or equal to about 80 mol %, based on 100 mol % of metals excluding lithium in the lithium transition metal composite oxide. The nickel content in the high nickel positive electrode active material may be, e.g., greater than or equal to about 85 mol %, greater than or equal to about 90 mol %, greater than or equal to about 91 mol %, or greater than or equal to about 94 mol % and less than or equal to about 99 mol % based on 100 mol % of metals excluding lithium. The high-nickel positive electrode active materials may achieve high capacity and may be applied to high-capacity, high-density rechargeable lithium batteries.

In an implementation, a compound represented by any of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0<b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L_{d}¹GₑO₂ (0.90≤a≤1.8, 0≤b≤0.9, 0≤c≤0.5, 0 ≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)} Fe₂(PO₄)₃(0≤f≤2); and LiₐFePO₄ (0.90≤a≤1.8)

In the above chemical formulas, A may be, e.g., Ni, Co, Mn, or a combination thereof; X may be, e.g., Al, Ni, Co, Mn, Cr, Fe, Mg, Sr, V, a rare earth element, or a combination thereof; D may be, e.g., O, F, S, P, or a combination thereof; G may be, e.g., Al, Cr, Mn, Fe, Mg, La, Ce, Sr, V, or a combination thereof.

The positive electrode active material may include, e.g., lithium nickel oxide represented by Chemical Formula 11, lithium cobalt oxide represented by Chemical Formula 12, a lithium iron phosphate compound represented by Chemical Formula 13, and cobalt-free lithium nickel manganese oxide represented by Chemical Formula 14, or a combination thereof.

Liₐ₁Niₓ₁M_{y1}¹M_{z1}²O_{2-b1}X_{b1} [Chemical Formula 11]

In Chemical Formula 11, 0.95≤a1≤1.8, 0.33≤x1≤1, 0≤y1≤0.7, 0≤z1≤0.7, 0.9≤x1+y1+z1≤1.1, and 0≤b1≤0.1, M¹ and M² may each independently be, e.g., Al, B, Ba, Ca, Ce, Co, Cr, Cu, Fe, Mg, Mn, Mo, Nb, Si, Sn, Sr, Ti, V, W, or Zr, and X may be, e.g., F, P, or S.

Liₐ₂Coₓ₂M_{y2}³O_{2-b2}X_{b2} [Chemical Formula 12]

In Chemical Formula 12, 0.9≤a2≤1.8, 0.7≤x2≤1, 0≤y2≤0.3, 0.9≤x2+y2≤1.1, and 0≤b2≤0.1, M³ may be, e.g., Al, B, Ba, Ca, Ce, Cr, Cu, Fe, Mg, Mn, Mo, Ni, Se, Si, Sn, Sr, Ti, V, W, Y, Zn, or Zr, and X may be, e.g., F, P, or S.

Liₐ₃Feₓ₃M_{y3}⁴PO_{4-b3}X_{b3} [Chemical Formula 13]

In Chemical Formula 13, 0.9≤a3≤1.8, 0.6≤x3≤1, 0≤y3≤0.4, and 0≤b3≤0.1, M⁴ may be, e.g., Al, B, Ba, Ca, Ce, Co, Cr, Cu, Mg, Mn, Mo, Ni, Se, Si, Sn, Sr, Ti, V, W, Y, Zn, or Zr, and X may be, e.g., F, P, or S.

Liₐ₄Niₓ₄Mn_{y4}M_{z4}⁵O_{2-b4}X_{b4} [Chemical Formula 14]

In Chemical Formula 14, 0.9≤a4≤1.8, 0.8≤x4<1, 0<y4<0.2, 0≤z4≤0.2, 0.9≤x4+y4+z4≤1.1, and 0≤b4≤0.1, M⁵ may be, e.g., Al, B, Ba, Ca, Ce, Cr, Fe, Mg, Mo, Nb, Si, Sn, Sr, Ti, V, W, or Zr, and X may be, e.g., F, P, or S.

The average particle diameter (D₅₀) of the positive electrode active material may be, e.g., about 1 μm to about 25 μm, e.g., about 3 μm to about 25 μm, about 1 μm to about 20 μm, about 1 μm to about 18 μm, about 3 μm to about 15 μm, or about 5 μm to about 15 μm. In an implementation, the positive electrode active material may include small particles having an average particle diameter (D₅₀) of about 1 μm to about 9 μm and large particles having an average particle diameter (D₅₀) of about 10 μm to about 25 μm. The positive electrode active material having this particle size range may be harmoniously mixed with other components within the positive electrode active material layer and may achieve high capacity and high energy density. Herein, the average particle diameter may be obtained by selecting about 20 particles at random in the scanning electron microscope image of the positive electrode active material, measuring the particle diameter (e.g., diameter, long axis, or length of the long axis) to obtain the particle size distribution, and taking the diameter (D₅₀) of particles with a cumulative volume of 50 volume % as the average particle diameter in the particle size distribution.

The positive electrode active material may be in the form of secondary particles made by agglomerating a plurality of primary particles, or may be in the form of single particles. In an implementation, the positive electrode active material may have a spherical or close to spherical shape, or may have a polyhedral or irregular shape.

Meanwhile, the positive electrode active material may include a buffer layer on the particle surface. The buffer layer may be expressed as a coating layer, a protective layer, or the like, and may play a role in lowering the interfacial resistance between the positive electrode active material and the sulfide solid electrolyte particles. In an implementation, the buffer layer may include lithium-metal-oxide, wherein the metal may be, e.g., Al, B, Ca, Ce, Cr, Fe, Mg, Mo, Nb, Si, Sn, Sr, Ta, V, W, or Zr. The lithium-metal-oxide may be excellent for improving the performance of the positive electrode active material by facilitating the movement of lithium ions and electronic conduction, while lowering the interfacial resistance between the positive electrode active material and solid electrolyte particles.

The positive electrode active material may be included in an amount of about 55 wt % to about 99.5 wt %, e.g., about 65 wt % to about 95 wt %, or about 75 wt % to about 91 wt %, based on 100 wt % of the positive electrode active material layer.

### Binder

The binder may help improve binding properties of positive electrode active material particles with one another and with a current collector. In an implementation, the binder may include, e.g., polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon.

### Conductive Material

The conductive material may be included to provide electrode conductivity and a suitable electrically conductive material that does not cause a chemical change in the battery may be used. Examples of the conductive material may include a carbon material, e.g., natural graphite, artificial graphite, carbon black, acetylene black, ketjen black, a carbon fiber, a carbon nanofiber, a carbon nanotube, or the like; a metal material of a metal powder or a metal fiber including copper, nickel, aluminum, silver, or the like; a conductive polymer, e.g., a polyphenylene derivative; or a mixture thereof.

The contents of the binder and the conductive material may be, e.g., about 0.5 wt % to about 5 wt %, respectively, based on 100 wt % of the positive electrode active material layer.

The positive electrode active material layer may optionally further include a solid electrolyte. The solid electrolyte may include, e.g., a sulfide solid electrolyte, an oxide solid electrolyte, a halide solid electrolyte, or a combination thereof, and detailed descriptions thereof will be provided later in the solid electrolyte layer section.

Based on 100 wt % of the positive electrode active material layer, the solid electrolyte may be included in an amount of about 0.1 wt % to about 35 wt %, e.g., about 1 wt % to about 35 wt %, about 5 wt % to about 30 wt %, about 8 wt % to about 25 wt %, or about 10 wt % to about 20 wt %.

In the positive electrode active material layer, based on a total of 100 wt % of the positive electrode active material and the solid electrolyte, about 65 wt % to about 99 wt % of the positive electrode active material and about 1 wt % to about 35 wt % of the solid electrolyte may be included, e.g., about 80 wt % to about 90 wt % of the positive electrode active material and about 10 wt % to about 20 wt % of the solid electrolyte. Including the solid electrolyte in the positive electrode within the above ranges may help ensure that the efficiency and cycle-life characteristics of the all-solid-state rechargeable battery may be improved without reducing the capacity. The current collector may include Al.

### Negative Electrode

The negative electrode for an all-solid-state rechargeable battery may include, e.g., a current collector and a negative electrode active material layer on the current collector. The negative electrode active material layer may include a negative electrode active material and may further include a binder or a conductive material.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, e.g., crystalline carbon, amorphous carbon, or a combination thereof as a carbon negative electrode active material. The crystalline carbon may be, e.g., irregular or sheet, flake, spherical, or fiber shaped natural graphite or artificial graphite. The amorphous carbon may be, e.g., a soft carbon, a hard carbon, a mesophase pitch carbonization product, calcined coke, or the like.

The lithium metal alloy may include an alloy of lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be, e.g., a Si negative electrode active material or a Sn negative electrode active material. The Si negative electrode active material may include, e.g., silicon, a silicon-carbon composite, SiOₓ (0<x<2), a Si-Q alloy (wherein Q may be, e.g., an alkali metal, an alkaline-earth metal, a Group 13 element, a Group 14 element (excluding Si), a Group 15 element, a Group 16 element, a transition metal, a rare earth element, or a combination thereof), or a combination thereof. The Sn negative electrode active material may be, e.g., Sn, SnO₂, a Sn alloy, or a combination thereof.

The silicon-carbon composite may be, e.g., a composite of silicon and amorphous carbon. In an implementation, the silicon-carbon composite may be in the form of silicon particles and amorphous carbon coated on the surface of the silicon particles. In an implementation, it may include a secondary particle (core) in which silicon primary particles may be assembled and an amorphous carbon coating layer (shell) on the surface of the secondary particle. The amorphous carbon may also be present between the silicon primary particles, e.g., the silicon primary particles may be coated with amorphous carbon. The secondary particles may exist dispersed in an amorphous carbon matrix.

The silicon-carbon composite may further include crystalline carbon. In an implementation, the silicon-carbon composite may include a core including crystalline carbon and silicon particles and an amorphous carbon coating layer on the surface of the core.

The Si negative electrode active material or Sn negative electrode active material may be mixed with the carbon negative electrode active material.

In the negative electrode active material layer, the negative electrode active material may be included in an amount of about 95 wt % to about 99 wt %, based on a total weight of the negative electrode active material layer. In an implementation, the negative electrode active material layer may include about 90 wt % to about 99 wt % of the negative electrode active material, about 0.5 wt % to about 5 wt % of the binder, and about 0 wt % to about 5 wt % of the conductive material.

The binder may help well adhere the negative electrode active material particles to each other and also may help adhere the negative electrode active material to the current collector. The binder may be, e.g., a non-aqueous binder, an aqueous binder, a dry binder, or a combination thereof.

The non-aqueous binder may include, e.g., polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include, e.g., a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

If an aqueous binder is used as the negative electrode binder, a cellulose compound capable of imparting viscosity may be further included. As the cellulose compound carboxymethyl cellulose, hydroxypropylmethyl cellulose, methyl cellulose, or alkali metal salts thereof may be mixed and used. The alkali metal may be, e.g., Na, K, or Li.

The dry binder may be a polymer material capable of becoming fiber, and may be, e.g., polytetrafluoroethylene, polyvinylidene fluoride, a polyvinylidene fluoride-hexafluoropropylene copolymer, polyethylene oxide, or a combination thereof.

The conductive material may be included to provide electrode conductivity and a suitable electrically conductive material that does not cause a chemical change in the battery may be used. Examples of the conductive material include a carbon material, e.g., natural graphite, artificial graphite, carbon black, acetylene black, ketjen black, a carbon fiber, a carbon nanofiber, a carbon nanotube, or the like; a metal material of a metal powder or a metal fiber including copper, nickel, aluminum silver, or the like; a conductive polymer, e.g., a polyphenylene derivative; or a mixture thereof.

The negative electrode current collector may include, e.g., a copper foil, a nickel foil, a stainless steel foil, a titanium foil, a nickel foam, a copper foam, a polymer substrate coated with a conductive metal, or a combination thereof.

In an implementation, the negative electrode for an all-solid-state rechargeable battery may be a precipitation-type negative electrode. The precipitation-type negative electrode may not include a negative electrode active material during battery assembly, but may refer to a negative electrode in which, e.g., lithium metal, is precipitated or electrodeposited during battery charging, thereby serving as a negative electrode active material.

### (Precipitation-Type Negative Electrode)

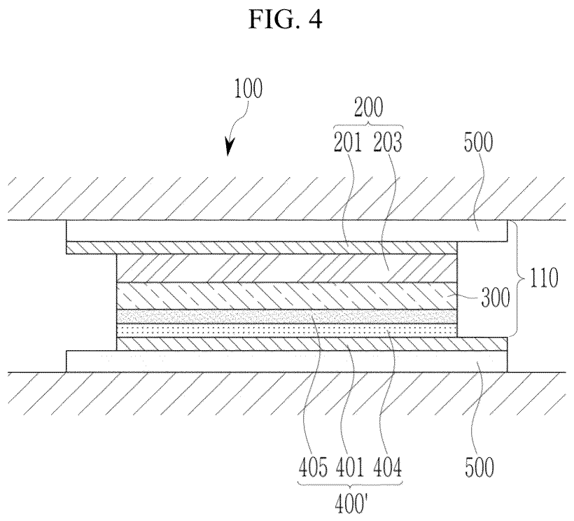

FIG. 4 is a schematic cross-sectional view of an all-solid-state rechargeable battery including a precipitation-type negative electrode. Referring to FIG. 4, the precipitation-type negative electrode 400′ may include a negative electrode current collector 401 and a negative electrode coating layer 405 on the current collector. In an all-solid-state rechargeable battery having such a precipitation-type negative electrode 400′, initial charging may begin in the absence of negative electrode active material, and during charging, high-density lithium metal may be precipitated or electrodeposited between the negative electrode current collector 401 and the negative electrode coating layer 405 or on the negative electrode coating layer 405 to form a lithium metal layer 404, which may serve as a negative electrode active material. In an implementation, in an all-solid-state rechargeable battery that has been charged at least once, the precipitation-type negative electrode 400′ may include, e.g., a negative electrode current collector 401, a lithium metal layer 404 on the negative electrode current collector 401, and a negative electrode coating layer 405 on the lithium metal layer 404. The lithium metal layer 404 may be referred to as a layer in which, e.g., lithium metal, may be precipitated during the charging process of the battery, and may be referred to as a metal layer, lithium layer, lithium electrodeposition layer, or negative electrode active material layer.

The negative electrode coating layer 405 may also be referred to as a lithium electrodeposition inducing layer or a negative electrode catalyst layer, and may include, e.g., a metal, a carbon material, or a combination thereof.

The metal may be a lithiophilic metal and may include, e.g., gold, platinum, palladium, silicon, silver, aluminum, bismuth, tin, zinc, or a combination thereof, and may be composed of one of these or various types of alloys. If the lithiophilic metal exists in particle form, its average particle diameter (D₅₀) may be less than or equal to about 4 μm, e.g., about 10 nm to about 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, denka black, ketjen black, or a combination thereof.

If the negative electrode coating layer 405 includes both the metal and the carbon material, the mixing ratio of the metal and the carbon material may be, e.g., a weight ratio of about 1:10 to about 2:1. In this case, precipitation of lithium metal may be effectively promoted and the characteristics of the all-solid-state rechargeable battery may be improved. In an implementation, the negative electrode coating layer 405 may include a carbon material on which a catalyst metal may be supported, or may include a mixture of metal particles and carbon material particles.

In an implementation, the negative electrode coating layer 405 may include the lithiophilic metal and amorphous carbon, and in this case, it may effectively promote precipitation of lithium metal. In an implementation, the negative electrode coating layer 405 may include a composite in which a lithiophilic metal may be supported on amorphous carbon.

The negative electrode coating layer 405 may further include a binder, and the binder may be, e.g., a conductive binder. In an implementation, the negative electrode coating layer 405 may further include general additives, e.g., a filler, a dispersant, an ion conductive agent, or the like.

A thickness of the negative electrode coating layer 405 may be, e.g., about 100 nm to about 20 μm, or about 500 nm to about 10 μm, or about 1 μm to about 5 μm.

The precipitation-type negative electrode 400′ may further include a thin film, e.g., on the surface of the current collector, i.e., between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, or the like, which may be used alone or an alloy of more than one. The thin film may further planarize a precipitation shape of the lithium metal layer 404 and may improve characteristics of the all-solid-state rechargeable battery. The thin film may be formed, e.g., through a vacuum deposition method, a sputtering method, a plating method, or the like. The thin film may have, e.g., a thickness of about 1 nm to about 500 nm.

The lithium metal layer 404 may include a lithium metal or a lithium alloy. The lithium alloy may be, e.g., a Li—Al alloy, a Li—Sn alloy, a Li—In alloy, a Li—Ag alloy, a Li—Au alloy, a Li—Zn alloy, a Li—Ge alloy, or a Li—Si alloy.

A thickness of the lithium metal layer 404 may be, e.g., about 1 μm to about 500 μm, about 1 μm to about 200 μm, about 1 μm to about 100 μm, or about 1 μm to about 50 μm. If the thickness of the lithium metal layer 404 is too thin, it may be difficult to perform the role of a lithium storage, and if it is too thick, the battery volume may increase and performance may deteriorate.

If using such a precipitation-type negative electrode, the negative electrode coating layer 405 may serve to protect the lithium metal layer 404 and suppress the precipitation growth of lithium dendrite. In an implementation, short circuit and capacity degradation of the all-solid-state battery may be suppressed and cycle-life characteristics may be improved.

### Solid Electrolyte Layer

The solid electrolyte layer may include a solid electrolyte. The solid electrolyte may be a type of inorganic solid electrolyte, and may include, e.g., a sulfide solid electrolyte, an oxide solid electrolyte, a halide solid electrolyte, or a combination thereof. The solid electrolyte layer according to some embodiments may include a sulfide solid electrolyte.

### Sulfide Solid Electrolyte

The sulfide solid electrolyte may include, e.g., Li₂S—P₂S₅, Li₂S—P₂S₅—LiX (wherein X may be, e.g., a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are integers and Z may be, e.g., Ge, Zn, or Ga), Li₂S—GeS₂, Li₂S—SiS₂—Li₃PO₄, Li₂S—SiS₂-LiₚMO_{q} (wherein p and q are integers and M may be, e.g., P, Si, Ge, B, Al, Ga, or In), or a combination thereof.

The sulfide solid electrolyte may be obtained by, e.g., mixing Li₂S and P₂S₅ in a molar ratio of about 50:50 to about 90:10 or about 50:50 to about 80:20 and optionally performing heat-treatment. Within the above mixing ratio ranges, a sulfide solid electrolyte having excellent ionic conductivity may be prepared. The ionic conductivity may be further improved by adding SiS₂, GeS₂, B₂S₃, or the like as other components thereto.

Mechanical milling or a solution method may be applied as a mixing method of sulfur-containing raw materials for preparing a sulfide solid electrolyte. The mechanical milling may make starting materials into particulates by putting the starting materials in a ball mill reactor and vigorously stirring them. The solution method may be performed by mixing the starting materials in a solvent to obtain a solid electrolyte as a precipitate. In an implementation, a heat treatment may be performed after mixing and, in this case, crystals of the solid electrolyte may be more robust and ionic conductivity may be improved. In an implementation, the sulfide solid electrolyte may be prepared by mixing sulfur-containing raw materials and performing a heat treatment two or more times. In this case, a sulfide solid electrolyte having high ionic conductivity and robustness may be prepared.

The sulfide solid electrolyte particles according to some embodiments, e.g., may be prepared through a first heat treatment performed by mixing sulfur-containing raw materials and firing at, e.g., about 120° C. to about 350° C. and a second heat treatment performed by mixing the resultant of the first heat treatment and firing the same at, e.g., about 350° C. to about 800° C. The first heat treatment and the second heat treatment may be performed in an inert gas or nitrogen atmosphere, respectively. The first heat treatment may be performed, e.g., for about 1 hour to about 10 hours, and the second heat treatment may be performed, e.g., for about 5 hours to about 20 hours. Small raw materials may be milled through the first heat treatment, and a final solid electrolyte may be synthesized through the second heat treatment. Through two or more such heat treatments, a sulfide solid electrolyte having high ionic conductivity and high performance may be obtained, and such a solid electrolyte may be suitable for mass production. The temperature of the first heat treatment may be, e.g., about 150° C. to about 330° C., or about 200° C. to about 300° C., and the temperature of the second heat treatment may be, e.g., about 380° C. to about 700° C., or about 400° C. to about 600° C.

In an implementation, the sulfide solid electrolyte particles may include argyrodite-type sulfide. The argyrodite-type sulfide solid electrolyte particle may have high ionic conductivity close to the range of about 10-4 to about 10-2 S/cm, which is the ionic conductivity of liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including the same may have improved battery performance, e.g., rate capability, coulombic efficiency, and cycle-life characteristics.

In an implementation, the argyrodite-type sulfide solid electrolyte particles may include a compound represented by Chemical Formula 21.

(LiₐM_{b}¹M_{c}²)(P_{d}Mₑ³)(S_{f}M_{g}⁴)Xₕ [Chemical Formula 21]

In Chemical Formula 21, 4≤a≤8, M¹ may be, e.g., Mg, Cu, Ag, or a combination thereof, 0≤b<0.5, M² may be, e.g., Na, K, or a combination thereof, 0≤c<0.5, M³ may be, e.g., Sn, Zn, Si, Sb, Ge, or a combination thereof, 0<d<4, 0≤e<1, M⁴ may be, e.g., O, SOₙ, N, or a combination thereof, 1.5≤n≤5, 3≤f≤12, 0≤g<2, and X may be, e.g., F, Cl, Br, I, or a combination thereof, and 0≤h≤2.

In an implementation, in Chemical Formula 21, a halide element (X) may be necessarily included, and in this case, it may be expressed as 0<h≤2. In an implementation, the M¹ element may be necessarily included in Chemical Formula 21, and in this case, it may be expressed as 0<b<0.5. In Chemical Formula 21, M³ may be understood as an element substituted for P and may be 0<e<1. In Chemical Formula 21, M⁴ may be substituted for S and, e.g., may be 0<g<2, and f, a ratio of S, may be, e.g., 3≤f≤7. If M⁴ is SOₙ, SOₙ may be, e.g., S₄O₆, S₃O₆, S₂O₃, S₂O₄, S₂O₅, S₂O₆, S₂O₇, S₂O₈, SO₄, or SO₅, and, e.g., may be SO₄. In an implementation, in Chemical Formula 21, a+b+c+h=7, d+e=1, and f+g+h=6.

In an implementation, the argyrodite-type sulfide solid electrolyte particles may include, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15}) Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof.

The argyrodite-type sulfide solid electrolyte may be prepared, e.g., by mixing lithium sulfide and phosphorus sulfide, and optionally lithium halide. A heat treatment may be performed after mixing them. The heat treatment may be carried out at a temperature range of about 400° C. to about 600° C., e.g., about 450° C. to about 500° C., or about 460° C. to about 490° C., for about 5 hours to about 30 hours, about 10 hours to about 24 hours, or about 15 hours to about 20 hours. If the heat treatment is performed under the above conditions, ionic conductivity may be maximized. The heat treatment may include, e.g., two or more heat treatment steps. The method of preparing the argyrodite-type sulfide solid electrolyte may include, e.g., a first heat treatment in which raw materials are mixed and fired, e.g., at about 120° C. to about 350° C., and a second heat treatment in which the resultant of the first heat treatment is mixed again and fired, e.g., at about 350° C. to about 800° C.

An average particle diameter (D₅₀) of the sulfide solid electrolyte particles may be, e.g., about 0.1 μm to about 5.0 μm or about 0.1 μm to about 3.0 μm, and may be small particles of about 0.1 μm to about 1.9 μm or large particles of about 2.0 μm to about 5.0 μm. The sulfide solid electrolyte particles may be a mixture of small particles having an average particle diameter of about 0.1 μm to about 1.9 μm and large particles having an average particle diameter of about 2.0 μm to about 5.0 μm. The average particle diameter of the sulfide solid electrolyte particles may be measured using an electron microscope image, and, e.g., a particle size distribution may be obtained by measuring the size (diameter or length of the long axis) of about 20 particles in a scanning electron microscope image, and D₅₀ may be calculated therefrom.

### Oxide Solid Electrolyte

The oxide solid electrolyte may include, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (wherein M=Te, Nb, or Zr; x is an integer of 1 to 10), or a mixture thereof.

### Halide Solid Electrolyte

The solid electrolyte layer may further include, e.g., a halide solid electrolyte. The halide solid electrolyte may include a halogen element as a main component, meaning that a ratio of the halide element to all elements constituting the solid electrolyte may be, e.g., about 50 mol % or more, about 70 mol % or more, about 90 mol % or more, or about 100 mol %. In an implementation, the halide solid electrolyte may not include sulfur.

The halide solid electrolyte may include, e.g., a lithium element, a metal element other than lithium, and a halogen element. The metal element other than lithium may include, e.g., Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be, e.g., F, Cl, Br, I, or a combination thereof, and, e.g., it may be Cl, Br, or a combination thereof. The halide solid electrolyte may be, e.g., represented by LiₐM₁X₆ (M may be, e.g., Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X may be, e.g., F, Cl, Br, I, or a combination thereof, and 2≤a≤3). The halide solid electrolyte may include, e.g., Li₂ZrCl₆, Li_{2.7}Y_{0.7}Zr_{0.3}Cl₆, Li_{2.5} Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃ YCl₆, Li₃ YBr₂Cl₄, Li₃ YbCl₆, Li_{2.6}Hf_{0.4}Yb_{0.6}Cl₆, or a combination thereof.

### Binder

The solid electrolyte layer may further include a binder. The binder may include, e.g., a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

The binder may be included in an amount of about 0.1 wt % to about 3 wt %, e.g., about 0.5 wt % to about 2 wt %, about 0.5 wt % to about 1.5 wt %, based on 100 wt % of the solid electrolyte layer. Maintaining the amount of binder in the above ranges may help ensure components in the solid electrolyte layer may be well combined without reducing the ionic conductivity of the solid electrolyte, thereby improving durability and reliability of the battery.

### Other Components

The solid electrolyte layer may optionally further include, e.g., an alkali metal salt, an ionic liquid, or a conductive polymer.

The alkali metal salt may be, e.g., a lithium salt. A concentration of the lithium salt in the solid electrolyte layer may be greater than or equal to about 1 M, e.g., about 1 M to about 4 M. In this case, the lithium salt may improve ionic conductivity by improving lithium ion mobility of the solid electrolyte layer.

The lithium salt may be applied without type limitations, and may include, e.g., LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato) borate (LiBOB), lithium difluoro (oxalato) borate (LiDFOB), lithium difluorobis(oxalato)phosphate (LiDFBP), lithium bis(trifluoromethanesulfonyl)imide (LiTFSI), lithium bis(fluoro) sulfonyl)imide (LiFSI), lithium bis(pentafluoroethanesulfonyl)imide (LiBETI), lithium trifluoromethane sulfonate, lithium tetrafluoroethane sulfonate, or a combination thereof.

In an implementation, the lithium salt may be an imide lithium salt, e.g., LiTFSI, LiFSI, LiBETI, or a combination thereof. The imide lithium salt may maintain or improve ionic conductivity by appropriately maintaining chemical reactivity with the ionic liquid.

The ionic liquid may have a melting point below room temperature so it may be in a liquid state at room temperature and may refer to a salt or room temperature molten salt composed of ions alone.

The ionic liquid may be a compound including a) a cation, e.g., ammonium, pyrrolidinium, pyridinium, pyrimidinium, imidazolium, piperidinium, pyrazolium, oxazolium, pyridazinium, phosphonium, sulfonium, triazolium, and a mixture thereof, and b) an anion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, e.g., N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be, e.g., about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

The shape of the all-solid-state rechargeable battery may be a suitable shape, e.g., a coin-shaped, a button-shaped, a sheet-shaped, a laminated-shaped, a cylindrical shape, a flat type, or the like. In an implementation, the all-solid-state rechargeable battery may also be applied to large batteries used in electric vehicles, etc. In an implementation, the all-solid-state rechargeable battery may also be used in hybrid vehicles, e.g., plug-in hybrid electric vehicles (PHEV). In an implementation, it may be used in a field requiring a large amount of power storage, and may be used, e.g., in motorcycles or power tools. In an implementation, the all-solid-state rechargeable battery may be used in various fields, e.g., portable electronic devices.

Hereinafter, examples of the present embodiments and comparative embodiments are described. It is to be understood, however, that the examples are for the purpose of illustration and are not to be construed as limiting the present invention.

### Example 1

### 1. Manufacturing of Sealing Tape

A monomer mixture including 85 parts by weight of 2-ethylhexylacrylate, 5 parts by weight of 2-hydroxyethylacrylate, and 10 parts by weight of isobornyl acrylate was added to a four-necked flask equipped with a stirring blade, a thermometer, a nitrogen gas introduction tube, and a cooler. In addition, after adding 0.1 parts by weight of 2,2′-azobisisobutyronitrile as a polymerization initiator, 85 parts by weight of ethyl acetate, and 15 parts by weight of toluene, based on 100 parts by weight of the monomer mixture (solid content), thereto and while gently stirring the mixture, substituting with nitrogen by introducing nitrogen thereinto, a polymerization reaction was performed by maintaining a liquid temperature in the flask at about 55° C. for 8 hours, preparing a solution of an acryl polymer having a weight average molecular weight (Mw) of about 1,300,000 g/mol and M_{w}/Mₙ=1.84.

Subsequently, 0.1 parts by weight of an isocyanate crosslinking agent (xylylene diisocyanate (XDI), Takenate D110N, Mitsui Chemicals, Inc.) and 0.1 parts by weight of 3-glycidoxypropyltrimethoxysilane (KBM-403, Shin-Etsu Chemical Co., Ltd.), based on 100 parts by weight of a solid content of the obtained acryl polymer solution, were added thereto to prepare a solution.

The obtained solution was coated on one surface of a 25 μm-thick PET film and then, treated at 135° C. for 3 minutes, obtaining a sealing tape having an adhesive layer formed on one surface of the PET substrate.

2. Manufacturing of all-Solid-State Rechargeable Battery Including Sealing Tape

85 wt % of LiNi_{0.8}Co_{0.15}Mn_{0.05}O₂ positive electrode active material coated with Li₂O—ZrO₂, 13.5 wt % of lithium argyrodite-type solid electrolyte Li₆PS₅Cl, 1.0 wt % of polyvinylidene fluoride binder, and 0.5 wt % of carbon nanotube conductive material were mixed to prepare a positive electrode composition. The prepared positive electrode composition was coated on an aluminum positive electrode current collector, dried, and compressed to prepare a positive electrode.

A negative electrode coating layer composition was prepared by mixing carbon black, having a primary particle diameter (D₅₀) of about 30 nm, and silver (Ag), having an average particle diameter (D₅₀) of about 60 nm, in a weight ratio of 3:1 to prepare an Ag/C composite and adding 0.25 g of the composite to 2 g of an NMP solution including 7 wt % of a polyvinylidene fluoride binder and then, mixing them. This was coated on a nickel foil current collector using a bar coater and dried in vacuum to prepare a precipitated negative electrode with a negative electrode coating layer formed on the current collector.

An argyrodite-type solid electrolyte Li₆PS₅Cl (D₅₀=3 μm) was added to a binder solution in which an acrylic binder (SX-A334, Zeon) was dissolved in isobutyl isobutyrate (IBIB) solvent and stirred to prepare a slurry. The slurry included 98.5 wt % of the solid electrolyte and 1.5 wt % of the binder. The slurry was coated on a release PET film using a bar coater and dried at room temperature to prepare a solid electrolyte layer.

Bicell-type cell structures were manufactured by laminating layers in the order of negative electrode/solid electrolyte/positive electrode/solid electrolyte/negative electrode. Then, five cell structures were laminated by interposing an elastic sheet between the cell structures and on the outermost surface of the laminate, thereby manufacturing a final battery structure. This was inserted into an aluminum laminate film pouch and then, warm-isostatic-pressed (WIP) at 500 MPa for 30 minutes at 80° C. Subsequently, the sealing tape manufactured as described above was attached onto six or more regions of the outer surface of the pressed battery structure, as shown in FIG. 1, manufacturing a final all-solid-state rechargeable battery cell.

### Example 2

An all-solid-state rechargeable battery cell was manufactured substantially in the same manner as in Example 1 except that the isocyanate crosslinking agent, D110N, was used in an amount of 0.05 parts by weight instead of 0.1 parts by weight.

### Example 3

An all-solid-state rechargeable battery cell was manufactured substantially in the same manner as in Example 1 except that 90 parts by weight of n-butylacrylate instead of 85 parts by weight of 2-ethylhexylacrylate, 5 parts by weight of 2-hydroxybutyl acrylate instead of 5 parts by weight of 2-hydroxyethylacrylate, and isobornyl acrylate in an amount of 5 parts by weight of instead of 10 parts by weight were used.

### Comparative Example 1

An all-solid-state rechargeable battery cell was manufactured substantially in the same manner as in Example 1 except that 2-ethylhexylacrylate in an amount of 70 parts by weight instead of 85 parts by weight, 2-hydroxyethylacrylate in an amount of 10 parts by weight instead of 5 parts by weight, isobornyl acrylate in an amount of 20 parts by weight instead of 10 parts by weight were used.

### Comparative Example 2

An all-solid-state rechargeable battery cell was manufactured substantially in the same manner as in Example 1 except that a PET film 3221 series manufactured by Tapex was used instead of the sealing tape obtained in Example 1.

### Comparative Example 3

An all-solid-state rechargeable battery cell was manufactured substantially in the same manner as in Example 1 except that 70 parts by weight of n-butylacrylate instead of 85 parts by weight of the 2-ethylhexylacrylate, 2-hydroxybutyl acrylate instead of the 5 parts by weight of 2-hydroxyethylacrylate, isobornyl acrylate in an amount of 25 parts by weight instead of 10 parts by weight, and the isocyanate crosslinking agent D110N in an amount of 0.2 parts by weight instead of 0.1 parts by weight were used.

### Comparative Example 4

An all-solid-state rechargeable battery cell was manufactured substantially in the same manner as in Example 1 except that 2-ethylhexylacrylate in an amount of 65 parts by weight instead of the 85 parts by weight, 10 parts by weight of 2-hydroxybutylacrylate instead of 5 parts by weight of 2-hydroxyethylacrylate, isobornylacrylate in an amount of 25 parts by weight instead of 10 parts by weight, and 0.2 parts by weight of 1,6-hexanediol diacrylate (HDDA) instead of D110N as the crosslinking agent were used.

### Evaluation 1: Shear Strength

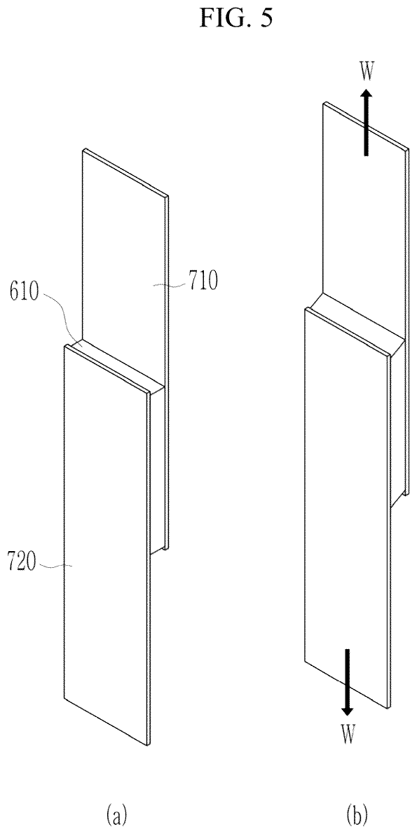

The sealing tapes according to the Examples and the Comparative Examples were respectively cut into a size of (1 in)×(1 in), preparing samples. Glass plates 710 and 720 were laminated onto both surfaces, e.g., opposite surfaces, of each of the prepared sealing tape samples 610, manufacturing specimens as shown in (a) of FIG. 5.

Shear strength was measured as a maximum value of shear stress, as shown in (b) of FIG. 5, by pulling both ends of the two glass plates 710 and 720 at 12.5 mm/min. Specifically, the specimens were allowed to stand at 25° C. for 2 hours and measured with respect to the shear strength by using UTM (AGS-X, SHIMADZU Corp.). In addition, the specimens were allowed to stand at 45° C. for 2 hours and then, measured with respect to the shear strength in the same manner as above. The results are shown in Table 1.

### Evaluation 2: Creep

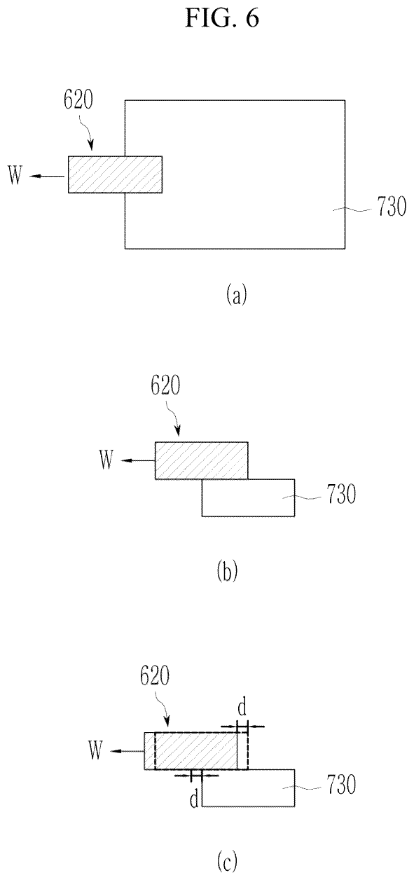

The sealing tapes according to the Examples and the Comparative Examples were respectively cut into a size with a width of 1 cm, preparing specimens. As shown in (a) and (b) of FIG. 6, each sealing tape specimen 620 was adhered at the end of the glass plate 730 to have an adhesive area of 1 cm×1 cm. Subsequently, the sealing tape specimen 620 was pulled by using a TA.XT Plus texture analyzer (Stable Micro Systems) at 10 μm/s at a load (W) of 1 kgf for 1 minute at 25° C. and 45° C. As shown in (c) of FIG. 6, the sealing tape specimen 620 might be pulled off from the glass plate 730, wherein a distance (creep, [μm]) that the sealing tape specimen was pulled off from the glass plate was measured. As a result, each creep of the adhesive layers at 25° C. and 45° C. and a ratio of the creep to a thickness of each of the adhesive layers is shown in Table 1. Herein, the thickness of each of the adhesive layers was measured through an image taken with an optical microscope, a scanning electron microscope, or the like.

### Evaluation 3: Adhesive Force

Each of the sealing tapes according to the Examples and the Comparative

Examples was maintained at 25° C. for 2 hours with a load of 50 kg and then, peeled off at 100 mm/min in a direction of 180° to measure a force required for peeling 40 mm, and the results are shown as an adhesive force in Table 1.

Evaluation 4: Evaluation of Electrochemical Properties of all-Solid-State Battery Cell

The all-solid-state battery cells, to which each of the tapes according to the Examples and the Comparative Examples was applied, were evaluated with respect to coulombic efficiency and cycle-life in the following methods. The evaluation results are shown in Table 1.

### (1) Coulombic Efficiency

The all-solid-state battery cells were respectively charged to an upper limit voltage of 4.25 V at a constant current of 0.1 C and discharged to a cut-off voltage of 2.5 V at 0.1 C at 45° C. for initial charge and discharge.

Coulombic efficiency(C.E.)=100*(initial discharge capacity/initial charge capacity) [Equation 1]

### (2) Cycle-Life

After measuring the coulombic efficiency, the cells were 300 times repeatedly charged and discharged at 0.33 C within a range of 2.5 V to 4.25 V at 45° C. to evaluate the number of cycles at which discharge capacity retention to initial discharge dropped to 80%.

TABLE 1

| | | Ex. | Ex. | Ex. | Comp. | Comp. | Comp. | Comp. |
|---|---|---|---|---|---|---|---|---|
| | | 1 | 2 | 3 | Ex. 1 | Ex. 2 | Ex. 3 | Ex. 4 |
| Thickness of adhesive layer | | 5 um | 10 um | 5 um | 5 um | 6 um | 25 um | 25 um |
| 25° C. | Adhesive force | 350 | 420 | 380 | 250 | 500 | 750 | 650 |
| | (180° Peel) | | | | | | | |
| | Shear strength | 4 | 2.88 | 3.8 | 3.6 | 3.3 | 4.5 | 4.8 |
| | (kgf/cm²) | | | | | | | |
| | Creep (um) | 50 | 75 | 65 | 140 | 180 | 60 | 55 |
| | Creep (um)/ | 10 | 7.5 | 13 | 28 | 30 | 2.4 | 2.2 |
| | thickness (um) | | | | | | | |
| 45° C. | Shear strength | 0.98 | 1.01 | 1.1 | 0.8 | 0.6 | 0.6 | 1.6 |
| | (kgf/cm²) | | | | | | | |
| | Creep (um) | 500↑ | 500↑ | 500↑ | 500↑ | 500↑ | 200 | 150 |
| | Creep (um)/ | 100 | 50 | 100 | 100 | 83.33333 | 8 | 6 |
| | thickness (um) | | | | | | | |

| | | | | | | | |
|---|---|---|---|---|---|---|---|
| C.E. | 93 | 94 | 93 | 90 | 90 | 85 | 83 |
| Cycle-life | >300 | >300 | >300 | 230 | 180 | 80 | 75 |

Referring to Table 1, the sealing tapes according to the Examples exhibited equivalent or excellent shear strength at 25° C., compared to the sealing tapes according to the Comparative Examples, and simultaneously, exhibited high creep and a high ratio of creep to a thickness of each of the adhesive layers at 45° C. and thus excellent high strain characteristics. In other words, the sealing tapes according to the Examples may not be separated from a cell structure in manufacturing all-solid-state rechargeable batteries but disperse stress applied to a solid electrolyte in the batteries during the charge and discharge and secure a uniform surface pressure, thereby increasing coulombic efficiency of the batteries.

By way of summation and review, some commercially available rechargeable lithium batteries may use an electrolyte solution including a flammable organic solvent, and there may be a safety concerns with such batteries in that they may explode or catch fire if collision or penetration occurs.

Accordingly, semi-solid batteries or all-solid-state batteries that avoid the use of electrolyte solutions have been proposed. An all-solid-state battery is a battery in which all materials are made of solid, particularly a battery that uses solid electrolytes. This all-solid-state battery has a merit of not being charged as there is no risk of explosion due to electrolyte solution leakage or the like, and that it is easy to manufacture a thin battery.

Some embodiments may provide a sealing tape for an all-solid-state rechargeable battery having high shear strength at room temperature and high strain characteristics at 45° C., which may be close to the charging and discharging conditions of the battery, so that the sealing tape may maintain high pressure in the laminating direction of the battery in normal times and maintain uniform pressure in the battery by exhibiting a high strain rate during charging and discharging.

Some embodiments may provide an all-solid-state rechargeable battery including the sealing tape for an all-solid-state rechargeable battery.

All-solid-state rechargeable batteries that apply the sealing tape according to some embodiments as a finishing tape may maintain high pressure in normal times and may receive uniform pressure on all sides of the battery during charging and discharging or under high-temperature conditions, helping eliminate localized stress concentration, improve cycle-life characteristics and reliability, and at the same time, improve coulombic efficiency.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A sealing tape for an all-solid-state rechargeable battery, comprising:
a substrate; and
an adhesive layer on a surface of the substrate,
wherein the sealing tape has a creep value of greater than or equal to about 500 μm at 45° C. and a shear strength of greater than or equal to about 0.98 kgf/cm² at 45° C.

2. The sealing tape as claimed in claim 1, wherein a ratio of the creep value to a thickness of the adhesive layer is greater than or equal to about 50 at 45° C.

3. The sealing tape as claimed in claim 1, wherein the sealing tape has a creep value of less than or equal to about 100 μm and a shear strength of greater than or equal to about 2.0 kgf/cm² at 25° C.

4. The sealing tape as claimed in claim 1, wherein a ratio of the creep value to a thickness of the adhesive layer is less than or equal to about 15 at 25° C.

5. The sealing tape as claimed in claim 1, wherein the sealing tape has an adhesive force of greater than or equal to about 300 gf/mm at 25° C.

6. The sealing tape as claimed in claim 1, wherein the sealing tape has a thickness of about 10 μm to about 100 μm.

7. The sealing tape as claimed in claim 1, wherein the substrate has a thickness of about 5 μm to about 50 μm.

8. The sealing tape as claimed in claim 1, wherein the adhesive layer has a thickness of about 5 μm to about 50 μm.

9. The sealing tape as claimed in claim 1, wherein the substrate includes polyethylene terephthalate, polyethylene, polypropylene, polyamide, polyimide, polyethylene naphthalate, polyacrylonitrile, poly(meth)acrylate, polymethyl(meth)acrylate, polyvinylidene fluoride, polytetrafluoroethylene, polyvinyl chloride, polyurethane, an epoxy resin, nylon resin, acryl resin, polystyrene, polyethylene oxide, polyvinyl alcohol, a silicone resin, a styrene-butadiene-rubber, an acrylonitrile-butadiene-rubber, hydrogenated nitrile-butadiene-rubber, or a copolymer thereof.

10. The sealing tape as claimed in claim 1, wherein:
the adhesive layer includes an adhesive polymer, and
a molecular weight of the adhesive polymer is about 800,000 g/mol to about 3,500,000 g/mol.

11. The sealing tape as claimed in claim 10, wherein a glass transition temperature of the adhesive polymer is about −50° C. to about −5° C.

12. The sealing tape as claimed in claim 10, wherein the adhesive polymer is derived from alkyl acrylate, hydroxyalkyl acrylate, cycloalkyl acrylate, or a combination thereof.

13. An all-solid-state rechargeable battery, comprising:
a battery assembly including a positive electrode, a solid electrolyte layer, a negative electrode; and
the sealing tape as claimed in claim 1 attached to at least a portion of the exterior of the battery assembly.

14. The all-solid-state rechargeable battery as claimed in claim 13, wherein the sealing tape is attached to four or more regions of the battery assembly.

15. The all-solid-state rechargeable battery as claimed in claim 13, wherein the sealing tape is attached to about 5 area % to about 40 area %, based on a total external area of the battery assembly.
